(19) United States
(12) Patent Application Publication
(10) Pub. No.: US 2019/0279629 A1
(43) Pub. Date: Sep. 12, 2019

(54) SPEECH SYSTEM

(71) Applicant: Toyota Jidosha Kabushiki Kaisha, Toyota-shi Aichi-ken (JP)

(72) Inventors: Keisuke Okamoto, Chofu-shi Tokyo (JP); Toshiki Endo, Shiki-shi Saitama-ken (JP); Toshihiko Watanabe, Kita-ku Tokyo (JP); Makoto Honda, Shinagawa-ku Tokyo (JP)

(73) Assignee: Toyota Jidosha Kabushiki Kaisha, Toyota-shi Aichi-ken (JP)

(21) Appl. No.: 16/294,081

(22) Filed: Mar. 6, 2019

(30) Foreign Application Priority Data
Mar. 8, 2018 (JP) 2018-042377

(51) Int. Cl. G10L 15/22; G10L 25/63; G06K 9/00

(52) U.S. Cl. CPC G10L 15/22; G10L 2015/223; G06K 9/00302; G10L 25/63

(57) ABSTRACT

A speech system includes a processor configured to acquire a situation value indicating a situation involving a plurality of persons based on pieces of emotion information indicating emotions of the plurality of persons, and control a speech of an object based on the acquired situation value.

### CROSS-REFERENCE TO RELATED APPLICATIONS

This application claims priority to Japanese Patent Application No. 2018-042377 filed on Mar. 8, 2018, incorporated herein by reference in its entirety.

### BACKGROUND

### 1. Technical Field

The present disclosure relates to a technology for controlling a speech of a virtual object or a real object such as a robot in an environment where a plurality of persons are present.

### 2. Description of Related Art

Japanese Patent Application Publication No. 2007-30050 discloses a robot that participates in a conference or a lecture. The robot acquires pieces of speech/behavior information from a plurality of users, and executes speech and behavior that reflect the users' speech and behavior at appropriate timings.

### SUMMARY

The robot disclosed in Japanese Patent Application Publication No. 2007-30050 acts to speak about participants' feelings on their behalf for the purpose of achieving satisfactory communications among the participants. The inventors of the present disclosure have focused on an atmosphere of an environment where a plurality of persons are present, and have found a possibility that an action of a virtual object or a real object such as a robot may favorably affect the atmosphere of the environment.

The present disclosure provides a technology for causing a virtual object or a real object to act so as to favorably affect an atmosphere of an environment.

A speech system according to an aspect of the present disclosure includes a processor configured to acquire a situation value indicating a situation involving a plurality of persons based on pieces of emotion information indicating emotions of the persons, and control a speech of an object based on the acquired situation value.

The processor may be configured to estimate an emotion of each of the persons based on a facial expression of the person and to estimate the emotion of the person based on a voice of a speech of the person and the emotion information may be emotion information obtained when emotion information estimated based on the facial expression and emotion information estimated based on the voice of the speech agree with each other.

The object may be a virtual object or a real object. The processor may be configured to control a speech of the virtual object or the real object. The real object is typified by a robot, but only needs to be a device having a voice output function.

According to this aspect, the processor is configured to control the speech of the object based on the situation value indicating the situation involving the persons. Thus, the situation involving the persons can be improved or affected favorably.

The processor may be configured to acquire the situation value based on a conversational situation involving the persons as well as the emotion information. Thus, the level of the quality of the atmosphere of the environment can be acquired more objectively.

The situation value indicating the situation involving the persons may be a value representing a level of a quality of an atmosphere of an environment where the persons are present. The situation value may be a value indicating one grade out of a plurality of grades into which the quality of the atmosphere is classified.

Thus, the processor is configured to control the speech of the object based on the level of the quality of the atmosphere of the environment so that the atmosphere of the environment can be improved or affected favorably.

The processor may be configured to decide whether to cause the object to make the speech based on the situation value.

The processor may be configured such that, when the processor acquires a situation value indicating that the atmosphere of the environment is bad, the processor decides to cause the object to make the speech.

The processor may be configured such that, when the processor acquires a situation value indicating that the atmosphere of the environment is good, the processor decides not to cause the object to make the speech.

The processor may be configured to estimate the emotions of the persons by identifying the individual trial expressions in face images of the persons, which are extracted from an image captured by a camera.

According to the present disclosure, it is possible to provide a technology for controlling the speech of the object based on the situation involving the plurality of persons.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating the schematic configuration of an information processing system;

FIG. 2 is a diagram illustrating a vehicle cabin;

FIG. 3 is a diagram illustrating functional blocks of the information processing system;

FIG. 4 is a diagram illustrating an example of a captured image;

FIG. 5 is a diagram illustrating an example of an atmosphere evaluation table;

FIG. 6A is a diagram illustrating an example of speech content of a character;

FIG. 6B is a diagram illustrating the example of the speech content of the character;

FIG. 7A is a diagram illustrating another example of the speech content of the character; and

FIG. 7B is a diagram illustrating the other example of the speech content of the character.

### DETAILED DESCRIPTION

An information processing system according to an embodiment estimates the emotions of occupants in a vehicle cabin, and acquires a situation value indicating a situation involving the occupants based on pieces of emotion information indicating the emotions of the occupants. The situation value may represent the quality level of an atmosphere in the vehicle cabin. The information processing system controls a speech of a virtual object displayed on an on-board display based on the situation value. Thus, the information processing system according to the embodiment constitutes a speech system configured to control the speech of the virtual object.

In the embodiment, the virtual object speaks to the occupants for the purpose of improving the atmosphere in the vehicle cabin. The target environment is not limited to the vehicle cabin, but may be a conversational space such as a conference room where a plurality of persons have conversations. The conversational space may be a virtual space where a plurality of persons are connected via the Internet by an electronic method. In the embodiment, the virtual object speaks to the occupants, but the speech may be made by a real object such as a robot.

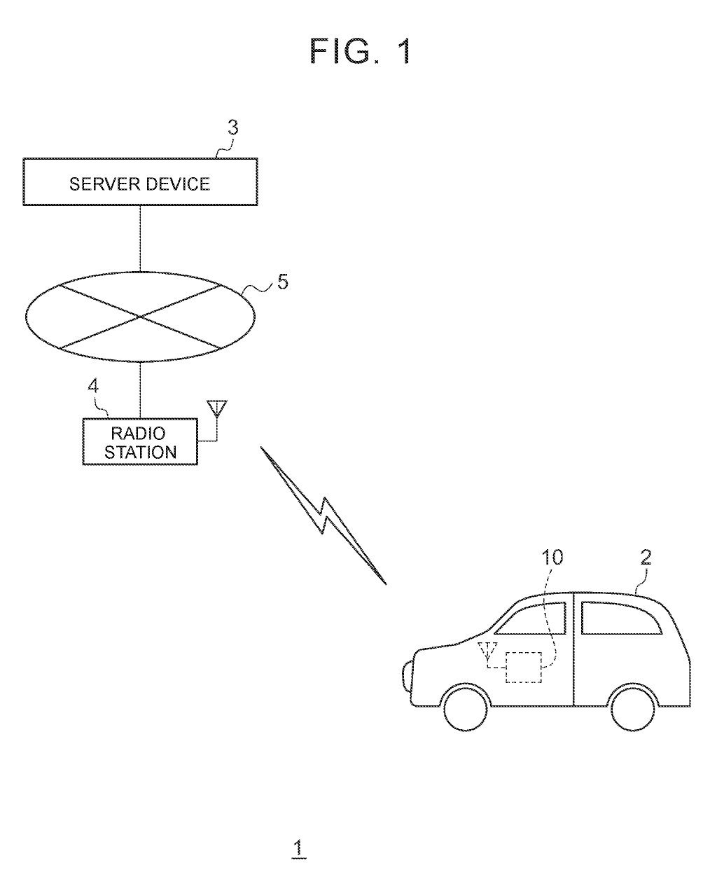

FIG. 1 illustrates the schematic configuration of an information processing system 1 according to the embodiment. The information processing system 1 includes an on-board device 10 and a server device 3. The on-board device 10 is mounted on a vehicle 2. The server device 3 is connected to a network 5 such as the Internet. For example, the server device 3 is installed in a data center, and has a function of processing data transmitted from the on-board device 10. The on-board device 10 is a terminal device having a function of executing radio communication with a radio station 4 serving as a base station, and is communicably connectable to the server device 3 via the network 5.

The information processing system 1 constitutes a speech system in which a character serving as the virtual object speaks to occupants of the vehicle 2. The character outputs a voice of words (speech content) that affect the atmosphere in the vehicle cabin. For example, if the atmosphere deteriorates due to a conflict of opinions during a conversation between the occupants, the character works toward improving the atmosphere of the environment by making a speech that relieves the occupants' feelings.

The speech system estimates the emotions of the occupants, generates pieces of emotion information indicating the emotions of the occupants, and acquires a situation value indicating a situation involving the plurality of occupants based on the pieces of emotion information. The situation value represents the quality level of the atmosphere in the vehicle cabin, and indicates one grade out of a plurality of grades into which the quality of the atmosphere is classified. The speech system decides whether the character will make a speech based on the situation value. When the character makes a speech, the speech system decides the speech content. Particularly when the situation value indicates that the atmosphere deteriorates, the character outputs a speech content that improves the atmosphere.

The processing of estimating the emotions of the occupants, the processing of deriving a situation value based on the estimated emotions of the occupants, and the processing of controlling a speech of an object based on the situation value may be executed by the server device 3 and/or the on-board device 10. For example, all the processing operations may be executed by the on-board device 10 or by the server device 3. If all the processing operations are executed by the server device 3, only the processing of making a speech from the object is executed by the on-board device 10. The emotion estimation processing requires image analysis, voice analysis, or other processing. Therefore, only the emotion estimation processing may be executed by the server device 3, and the other processing operations may be executed by the on-board device 10. The following description is directed to a case where the processing operations are mainly executed by the on-board device 10. In the speech system according to the embodiment, the executor is not limited to the on-board device 10.

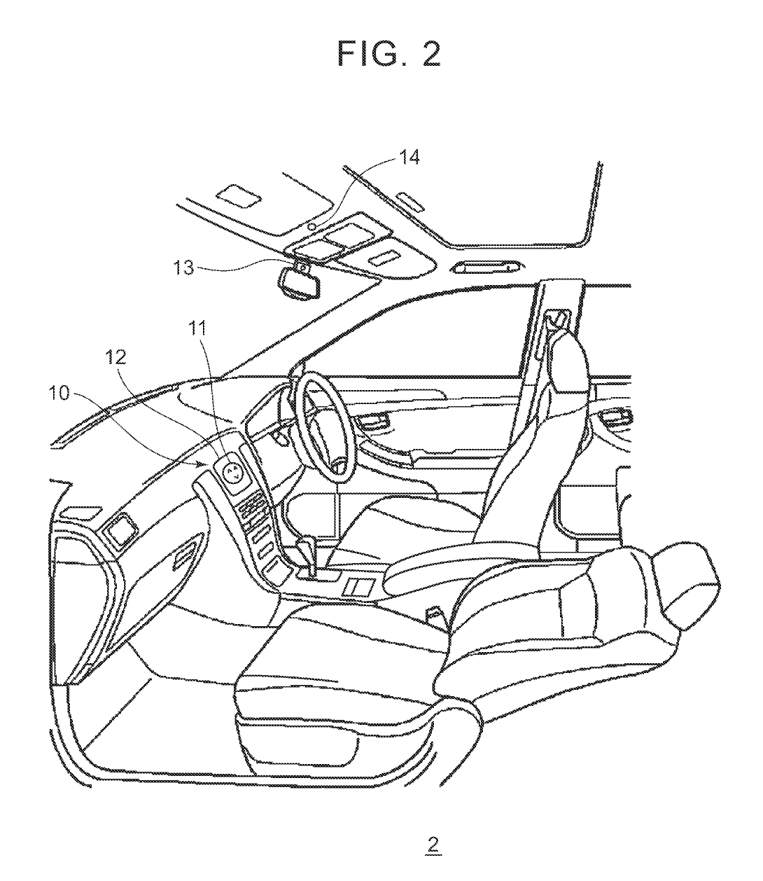

FIG. 2 illustrates the vehicle cabin. The on-board device 10 includes an output unit 12 capable of outputting an image and a voice. The output unit 12 includes an on-board display device and a loudspeaker. The on-board device 10 executes an agent application configured to provide information for the occupants. The agent application provides information for the occupants by using an image and/or a voice via a character 11 serving as the virtual object. In this example, the character 11 is represented by a face image, and the speech content of the character 11 is output as a voice from the loudspeaker. The speech content may be displayed on the on-board display device in the form of a speech balloon. The character 11 is not limited to the face image, but may be represented by a whole-body image or other types of image.

In the embodiment, the character 11 is controlled to make a speech so as to favorably affect the atmosphere between the occupants. Specifically, if the occupants have strong emotions of “anger” due to a conflict of opinions between the occupants, the character 11 works toward improving the atmosphere by making a speech that relieves their feelings. The vehicle 2 includes a camera 13 and a microphone 14. The camera 13 captures an image of the vehicle cabin. The microphone 14 acquires a voice in the vehicle cabin.

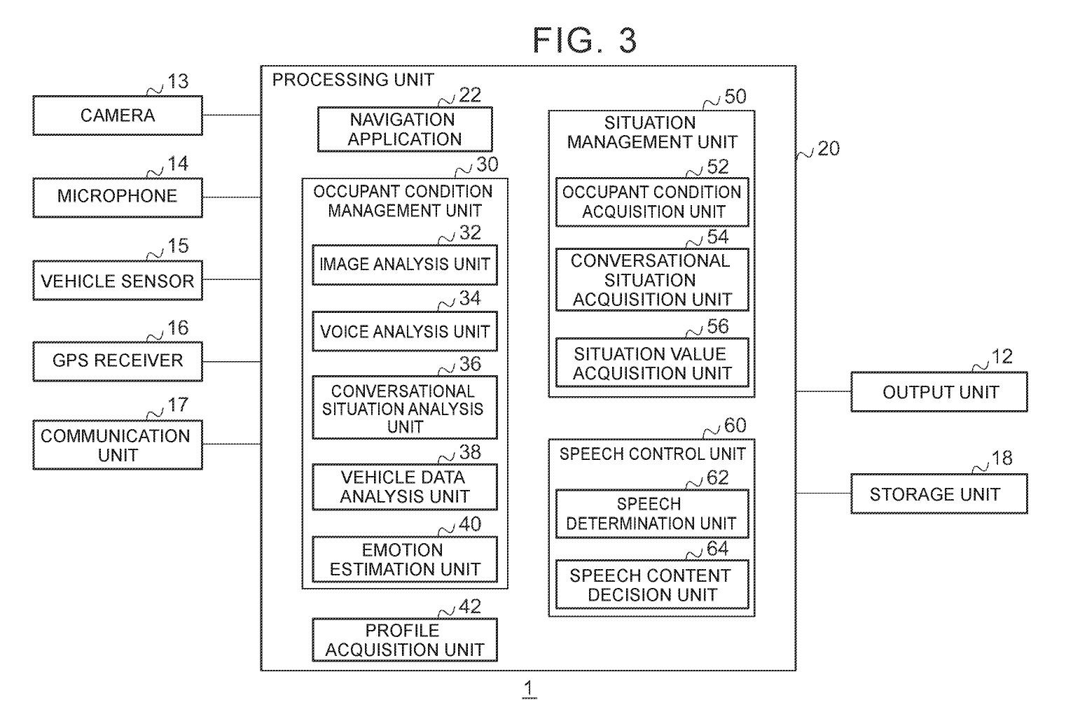

FIG. 3 illustrates functional blocks of the information processing system 1. The information processing system 1 includes a processing unit 20, a storage unit 18, the output unit 12, the camera 13, the microphone 14, a vehicle sensor 15, a global positioning system (GPS) receiver 16, and a communication unit 17. The output unit 12 serves as an input/output interface. The processing unit 20 is constituted by a processor such as a central processing unit (CPU), and implements functions of a navigation application 22, an occupant condition management unit 30, a profile acquisition unit 42, a situation management unit 50, and a speech control unit 60. The navigation application 22 provides the occupant condition management unit 30 with driving information on a driving distance, a driving time, and the like on a given day. The occupant condition management unit 30, the profile acquisition unit 42, the situation management unit 50, and the speech control unit 60 may be configured to implement one function of the agent application.

The occupant condition management unit 30 includes, an image analysis unit 32, a voice analysis unit 34, a conversational situation analysis unit 36, a vehicle data analysis unit 38, and an emotion estimation unit 40. The occupant condition management unit 30 estimates the emotions of the occupants in the vehicle cabin, and evaluates a conversational situation involving the plurality of occupants. The situation management unit 50 includes an occupant condition acquisition unit 52, a conversational situation acquisition unit 54, and a situation value acquisition unit 56. The speech control unit 60 includes a speech determination unit 62 and a speech content decision unit 64.

Various functions illustrated in FIG. 3 may be implemented by circuit blocks, memories, or other large-scale integrated circuits (LSI) in terms of hardware, and also implemented by, for example, system software or application programs loaded on a memory in terms of software. Thus, it is apparent to those skilled in the art that those functions are implemented in various forms by hardware alone, software alone, or a combination of hardware and software in the on-board device 10 and/or the server device 3, and the implementation method is not limited to any one of those methods.

The camera 13 captures an image of the occupants in the vehicle cabin. The camera 13 may be attached to a rear-view mirror so as to capture an image of the entire vehicle cabin. The image captured by the camera 13 is supplied to the processing unit 20, and the image analysis unit 32 analyzes the captured image.

FIG. 4 illustrates an example of the image captured by the camera 13. In this example, two persons are riding in the vehicle. An occupant A is a driver, and an occupant B is a passenger. The image analysis unit 32 detects the persons included in the captured image, and extracts face images of the persons. The image analysis unit 32 supplies the face images of the occupants to the emotion estimation unit 40 for the emotion estimation processing. At this time, the image analysis unit 32 supplies the face image of the occupant A to the emotion estimation unit 40 together with information indicating that the occupant A is the driver.

The storage unit 18 stores feature amounts of face images of registered users. The image analysis unit 32 executes processing of authenticating the face images of the occupants A and B by referring to the feature amounts of the face images of the registered users that are stored in the storage unit 18, thereby determining whether the occupants A and B are registered users. For example, if the vehicle 2 is a family car, the storage unit 18, may store feature amounts of face images of all family members. If the vehicle 2 is a company car, the storage unit 18 may store feature amounts of face images of employees who use the vehicle 2.

The image analysis unit 32 determines whether the occupants A and B are registered users by comparing the feature amounts of the face images of the registered users and the feature amounts of the face images of the occupants A and B. When the image analysis unit 32 determines that the occupants are registered users, the image analysis unit 32 supplies the face images of the occupants to the emotion estimation unit 40 together with identification information of the registered users.

The microphone 14 acquires a conversation between the occupants A and B in the vehicle cabin. Voice data acquired by the microphone 14 is supplied to the processing unit 20, and the voice analysis unit 34 analyzes the voice data.

The voice analysis unit 34 has a speaker recognition function to determine whether the voice data is voice data of the occupant A or voice data of the occupant B. Voice templates of the occupants A and B are registered in the storage unit 18, and the voice analysis unit 34 identifies the speaker by verifying the voice data against the voice templates stored in the storage unit 18.

When the occupants are not registered users, voice templates of the occupants are not registered in the storage unit 18. The voice analysis unit 34 has a speaker identification function for identifying a speaker who makes a speech in a conversation between a plurality of persons. Thus, the voice analysis unit 34 links the speech and the speaker together. At this time, the image analysis unit 32 may provide a timing of oral movement of the occupant, and the voice analysis unit 34 may synchronize the timing of oral movement with the timing of the voice data to determine whether the speech is a driver's speech or a passenger's speech.

The voice analysis unit 34 has a voice signal processing function to extract information on a speech rate, a volume, cadence, intonation, choice of words, and the like in the voice data. The voice analysis unit 34 has a voice recognition function to convert the voice data into text data. The voice analysis unit 34 supplies results of the voice analysis to the emotion estimation unit 40 for the emotion estimation processing, and also to the conversational situation analysis unit 36 for analysis of a conversational situation involving the occupants.

The conversational situation analysis unit 36 has a natural language processing function to analyze a conversational situation involving the occupants A and B based on the results of the voice analysis. The conversational situation analysis unit 36 executes natural language understanding to analyze the conversational situation as to, for example, whether the occupants A and B communicate well in a conversation, whether opinions conflict with each other, whether only one occupant is speaking and the other remains silent, and whether one occupant is only nodding in a perfunctory attitude. As the conversational situation, the conversational situation analysis unit 36 also analyzes, for example, how frequently a speech is made by a speaker, and whether there is a difference in terms of the volume. Through the analysis described above, the conversational situation analysis unit 36 evaluates the quality of the conversational situation. Specifically, the conversational situation analysis unit 36 decides an evaluation value for a current conversational situation based on a plurality of grades into which the quality of the conversational situation is classified, and stores the evaluation value in the storage unit 18. The evaluation value varies depending on the situation of the conversation between the occupants A and B.

The conversational situation analysis unit 36 evaluates the conversational situation by using evaluation values defined at five grades of “very good”, “good”, “fair”, “bad”, and “very bad”. The evaluation may be represented by numerical values. For example, “very good” may be set as Level 5, “good” may be set as Level 4, “fair” may be set as Level 3, “bad” may be set as Level 2, and “very bad” may be set as Level 1. The conversational situation analysis unit 36 monitors the conversational situation involving the occupants A and B. When the conversational situation changes, the conversational situation analysis unit 36 updates the evaluation value, and stores the evaluation value in the storage unit 18. Examples of the evaluation of the conversational situation are described below.

When the occupants A and B communicate well in a conversation and speak mutually at high frequencies, the conversational situation analysis unit 36 evaluates the conversational situation as “very good”. When the occupants A and B communicate well in a conversation and one occupant speaks at a high frequency while the other speaks at a low frequency, the conversational situation analysis unit 36 evaluates the conversational situation as “good”. When the occupants A and B communicate well in a conversation and speak at low frequencies, the conversational situation analysis unit 36 evaluates the conversational situation as “Pair”. When the occupants A and B have no conversation for a predetermined time or longer, the conversational situation analysis unit 36 evaluates the conversational situation as “bad”. When opinions of the occupants A and B conflict with each other, the conversational situation analysis unit 36 evaluates the conversational situation as “very bad”.

The profile acquisition unit 42 acquires pieces of user attribute information of the occupants A and B from the server device 3. The user attribute information may include information on the way of a user's speech, frequently used phrases, the way of listening to a speech, and the like. The conversational situation analysis unit 36 may evaluate the conversational situation involving the occupants based also on the user attribute information.

For example, it is assumed that the occupant A is a person who speaks frequently and the occupant B is a quiet person who does not speak actively. In this case, the situation in which the occupant A speaks at a high frequency and the occupant B speaks at a low frequency is quite likely to correspond to a very good conversational situation for the occupants A and B. In this manner, the conversational situation analysis unit 36 evaluates the situation of the conversation between the occupants by referring to the user attribute information of each occupant as well. Thus, the conversational situation analysis unit 36 can acquire an evaluation value based on a relationship between the occupants.

When the conversational situation analysis unit 36 evaluates the conversational situation, the conversational situation analysis unit 36 stores the evaluation value in the storage unit 18. The conversational situation changes from moment to moment, and therefore the conversational situation analysis unit 36 continues to monitor the conversation between the occupants. When the conversational situation changes, the conversational situation analysis unit 36 updates the evaluation value, and stores the evaluation value in the storage unit 18. The evaluation value of the conversational situation is used by the situation management unit 50 for processing of estimating the atmosphere in the vehicle cabin.

The vehicle sensor 15 corresponds to various sensors provided in the vehicle 2. For example, the vehicle sensor 15 includes a speed sensor, an acceleration sensor, and an accelerator position sensor. The vehicle data analysis unit 38 acquires sensor detection values from the vehicle sensor 15, and analyzes a driving situation of the driver. A result of the analysis is used for estimating the emotion of the occupant A who is the driver. For example, when the vehicle data analysis unit 38 determines that the vehicle 2 accelerates or brakes suddenly based on a detection value from the acceleration sensor, the vehicle data analysis unit 38 supplies the determination result to the emotion estimation unit 40. The vehicle data analysis unit 38 may analyze the driving situation of the driver by being supplied with information on, for example, a driving time up to the present from the navigation application 22. For example, when two or more hours have elapsed from the start of driving up to the present, the vehicle data analysis unit 38 may notify the emotion estimation unit 40 that the driving continues for two or more hours.

The emotion estimation unit 40 estimates the emotions of the occupants A and B in the vehicle cabin. The emotion estimation unit 40 estimates the emotions of the occupants based on facial expressions in the face images extracted by the image analysis unit 32 and the results of the voice analysis executed by the voice analysis unit 34. The emotion estimation unit 40 further uses the result of the driving situation analysis executed by the vehicle data analysis unit 38 for the processing of estimating the emotion of the occupant A who is the driver.

The emotion estimation unit 40 estimates the emotion of each occupant by deriving index values for emotion indices such as anger, fun, sadness, surprise, and tiredness. In the embodiment, the emotion of the occupant is estimated by using a simple model. The emotion estimation unit 40 represents each emotion index by using two types of index value. That is, the index value of “anger” is binary to indicate whether a person is angry or not. The index value of “fun” is binary to indicate whether a person has fun or not.

The emotion estimation unit 40 estimates the emotion of the occupant by identifying a facial expression in the face image of the occupant that is extracted by the image analysis unit 32. Hitherto, various researches have been conducted on a relationship between the emotion and the facial expression. The emotion estimation unit 40 may estimate the emotion of the occupant in the following manner.

In a case of a facial expression in which right and left eyebrows are pulled down and upper eyelids are raised, the emotion estimation unit 40 estimates that the emotion is “anger”. In a case of a facial expression in which the corners of lips are raised on both sides, the emotion estimation unit 40 estimates that the emotion is “fun”. In a case of a facial expression in which the inner corners of eyebrows are raised, upper eyelids droop, and the corners of lips are lowered on both sides, the emotion estimation unit 40 estimates that the emotion is “sadness”. In a case of a facial expression in which eyebrows are raised to arch and upper eyelids are also raised, the emotion estimation unit 40 estimates that the emotion is “surprise”.

The relationships between the emotion and the facial expression are stored in the storage unit 18 as a database. The emotion estimation unit 40 estimates the emotion of the occupant and generates emotion information based on the face image of the occupant that is extracted by the image analysis unit 32 by referring to the relationships in the database. The emotion of a person changes from moment to moment, and therefore the emotion estimation unit 40 continues to monitor the facial expression of the occupant. When a change in the facial expression is detected, the emotion estimation unit 40 updates the emotion information indicating the emotion based on the facial expression, and temporarily stores the emotion information in the storage unit 18.

The emotion estimation unit 40 estimates the emotion of the occupant based on the result of the voice analysis for the occupant that is executed by the voice analysis unit 34. Various methods are proposed to estimate an emotion based on a voice. The emotion estimation unit 40 may estimate the emotion based on the voice of the occupant by using an emotion estimator constructed by machine learning or the like. Further, the emotion estimation unit 40 may estimate the emotion based on a change in the feature of the voice. In any case, the emotion estimation unit 40 generates the emotion information indicating the emotion based on the voice of the occupant by using a known method, and temporarily stores the emotion information in the storage unit 18.

Although the description has been given of the acquisition of the user attribute information by the profile acquisition unit 42, the user attribute information may include data for estimating the emotion of the user, such as a facial expression and voice information associated with the emotion. In this case, the emotion estimation unit 40 may estimate the emotion of the user with high accuracy and generate emotion information by referring to the user attribute information.

As described above, the emotion estimation unit 40 estimates the emotion of the occupant based on the facial expression of the occupant, and also estimates the emotion of the occupant based on the voice of the speech of the occupant. The emotion estimation unit 40 adds information indicating the likelihood of the estimation to each of the emotion information generated in the system that is based on the facial expression and the emotion information generated in the system that is based on the voice of the speech.

When the pieces of emotion information generated in both systems agree with each other, the emotion estimation unit 40 notifies the situation management unit 50 of the emotion information. When the pieces of emotion information in both systems do not agree with each other, the emotion estimation unit 40 may select emotion information having a higher likelihood by referring to the likelihoods added to the pieces of emotion information in the respective systems. The emotion estimation unit 40 may estimate the emotion of the occupant A who is the driver based also on the result of the driving situation analysis executed by the vehicle data analysis unit 38. For example, when the driving time is long or when sudden acceleration or braking is detected at a high frequency, the emotion estimation unit 40 estimates that the occupant A is tired. Information indicating a likelihood is also added to the emotion information generated in the system that is based on the result of the driving situation analysis. The emotion estimation unit 40 decides the emotion information of the occupant by selecting emotion information having a higher likelihood out of the pieces of emotion information generated in the plurality of systems. Then, the emotion estimation unit 40 notifies the situation management unit 50 of the emotion information. When the emotion information generated in each system changes, the emotion estimation unit 40 selects one of the pieces of emotion information in the plurality of systems again, and notifies the situation management unit 50 of the selected emotion information.

In the situation management unit 50, the occupant condition acquisition unit 52 acquires the conditions of the occupants subjected to the estimation in the emotion estimation unit 40. In this example, the occupant condition acquisition unit 52 acquires the pieces of emotion information indicating the emotions of the occupants. The situation value acquisition unit 56 generates and acquires a situation value indicating a situation involving the plurality of occupants based on the pieces of emotion information of the occupants.

In the embodiment, the situation value acquired by the situation value acquisition unit 56 represents the quality level of an atmosphere of an environment where a plurality of occupants are present, that is, an atmosphere in the vehicle cabin. The situation value acquisition unit 56 acquires the situation value representing the quality level of the atmosphere in the vehicle cabin based on at least the pieces of emotion information of the occupants.

In the embodiment, the conversational situation acquisition unit 54 acquires the evaluation value of the conversational situation involving the occupants that is analyzed by the conversational situation analysis unit 36. The situation value acquisition unit 56 may acquire the situation value related to the atmosphere of the environment based not only on the pieces of emotion information of the occupants but also on the evaluation value of the conversational situation.

The situation value acquisition unit 56 acquires an evaluation value of the atmosphere based on an atmosphere evaluation table. In the atmosphere evaluation table, evaluation values of the atmosphere are associated with combinations of the pieces of emotion infbmation of the occupants and the conversational situation. The atmosphere evaluation table is stored in the storage unit 18.

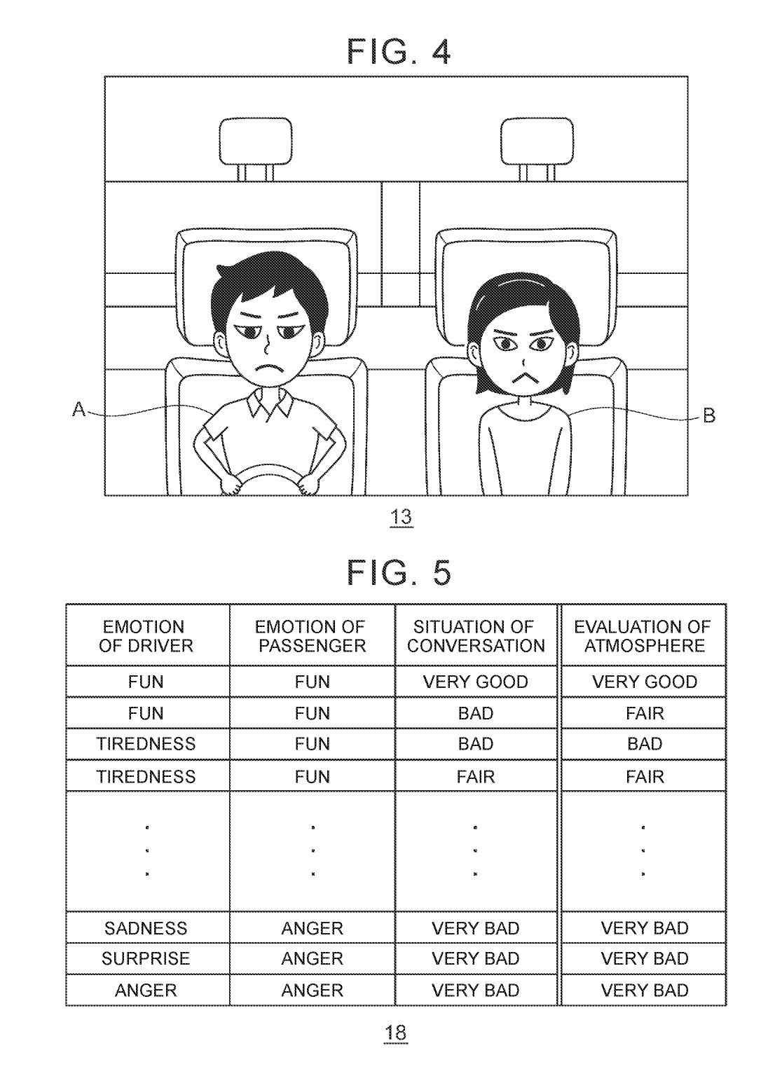

FIG. 5 illustrates an example of the atmosphere evaluation table. The atmosphere of the environment is evaluated based on the atmosphere evaluation table by using evaluation values defined at five grades of “very good”, “good”, “fair”, “bad”, and “very bad”. FIG. 5 illustrates combinations of the emotion of the driver, the emotion of one passenger, and the conversational situation. An actual atmosphere evaluation table is structured such that the evaluation values of the atmosphere are associated with combinations of the emotion of the driver, the emotions of two or more passengers, and the conversational situation.

Description is given of the evaluation values of the atmosphere illustrated in FIG. 5. When it is estimated that the emotion of the occupant A is “fun” and the emotion of the occupant B is “fun” and when the conversational situation is evaluated as “very good”, the situation value acquisition unit 56 acquires an evaluation value indicating that the atmosphere is “very good”.

When it is estimated that the emotion of the occupant A is “fun” and the emotion of the occupant B is “fun” and when the conversational situation is evaluated as “bad”, the situation value acquisition unit 56 acquires an evaluation value indicating that the atmosphere is “fair”. The conversational situation is evaluated as “bad” when the occupants have no conversation for a predetermined time or longer, but the atmosphere of the environment is evaluated as “fair” when both the emotions of the occupants A and B are estimated as “fun”.

When it is estimated that the emotion of the occupant A is “tiredness” and the emotion of the occupant B is “fun” and when the conversational situation is evaluated as “bad”, the situation value acquisition unit 56 acquires an evaluation value indicating that the atmosphere is “bad”. For example, when the occupant A is driving for a long time and has no conversation for a predetermined time or longer, the atmosphere of the environment is evaluated as “bad” even if the emotion of the occupant B is estimated as “fun”.

When it is estimated that the emotion of the occupant A is “tiredness” and the emotion, of the occupant B is “fun” and when the conversational situation is evaluated as “fair”, the situation value acquisition unit 56 acquires an evaluation value indicating that the atmosphere is “fair”. For example, when the occupant A is driving for a long time but the occupants A and B communicate well in a conversation, the atmosphere of the environment is evaluated as “fair” even if the emotion of the occupant A is estimated as “tiredness”.

When it is estimated that the emotion of the occupant A is “sadness” and the emotion of the occupant B “anger” and when the conversational situation is evaluated as “very bad”, the situation value acquisition unit 56 acquires an evaluation value indicating that the atmosphere is “very bad”. When it is estimated that the emotion of the occupant A is “surprise” and the emotion of the occupant B is “anger” and when the conversational situation is evaluated as “very bad”, the situation value acquisition unit 56 acquires an evaluation value indicating that the atmosphere is “very bad”. When it is estimated that the emotion of the occupant A is “anger” and the emotion of the occupant B is “anger” and when the conversational situation is evaluated as “very bad”, the situation value acquisition unit 56 acquires an evaluation value indicating that the atmosphere is “very bad”.

In the atmosphere evaluation table illustrated in FIG. 5, the evaluation value of the atmosphere is defined as “very bad” in the case where the emotion of one occupant is estimated as “anger” or in the case where the conversational situation is evaluated as “very bad”. The present disclosure is not limited to those cases. In a case where the occupants A and B are enjoying discussion, the conversational situation is evaluated as “very bad” because opinions conflict with each other, but the evaluation value of the atmosphere may be defined as “fair” when the emotions of the occupants A and B are estimated as “fun”.

The atmosphere evaluation table may be created based on, for example, previous emotion information and previous conversational situations by using a Bayesian network, or may be created by using other machine learning methods.

As described above, the situation value acquisition unit 56 acquires the situation value (evaluation value of the atmosphere), and stores the evaluation value of the atmosphere in the storage unit 18. The speech control unit 60 controls a speech of the character 11 serving as the virtual object based on the situation value acquired by the situation value acquisition unit 56.

Specifically, the speech determination unit 62 decides whether to cause the character 11 to make a speech based on the situation value. When the situation value indicates that the atmosphere of the environment is bad, the speech determination unit 62 decides to cause the character 11 to make a speech. When the situation value indicates that the atmosphere of the environment is good, the speech determination unit 62 decides to avoid causing the character 11 to make a speech.

The situation value of the atmosphere is any one of the evaluation values of “very good”, “good”, “fair”, “bad”, and “very bad”. The evaluation values of “very good” and “good” indicate that the atmosphere of the environment is good. The evaluation values of “bad” and “very bad” indicate that the atmosphere of the environment is bad. Thus, when the situation value indicates “bad” or “very bad”, the speech determination unit 62 decides to cause the character 11 to make a speech. When the situation value indicates “very good” or “good”, the speech determination unit 62 decides to avoid causing the character 11 to make a speech. When the situation value indicates “fair”, the speech determination unit 62 may decide to cause the character 11 to make a speech.

In the embodiment, when the situation value indicates “fair”, “bad”, or “very bad”, the speech determination unit 62 causes the character 11 to make a speech so as to improve the atmosphere of the environment. When the speech determination unit 62 determines that the character 11 will be caused to make a speech, the speech content decision unit 64 decides speech content based on the atmosphere of the environment. When the speech content decision unit 64 decides the speech content of the character 11, the speech content decision unit 64 may decide a speech content suited to the environment by referring to the pieces of user attribute information of the occupants that are acquired by the profile acquisition unit 42. The profile acquisition unit 42 may acquire group attribute information indicating, for example, a relationship between the occupants, and the speech content decision unit 64 may decide the speech content by referring to the group attribute information. For example, the group attribute information indicates that the occupants A and B have a family relationship or a superior-subordinate relationship. The group attribute information may include a history of previous conversations together with the relationship between the occupants A and B.

When the situation value indicates “very good” “good”, the speech determination unit 62 avoids causing the character 11 to make a speech because the atmosphere is already good and therefore the character 11 has little need to intervene in the environment.

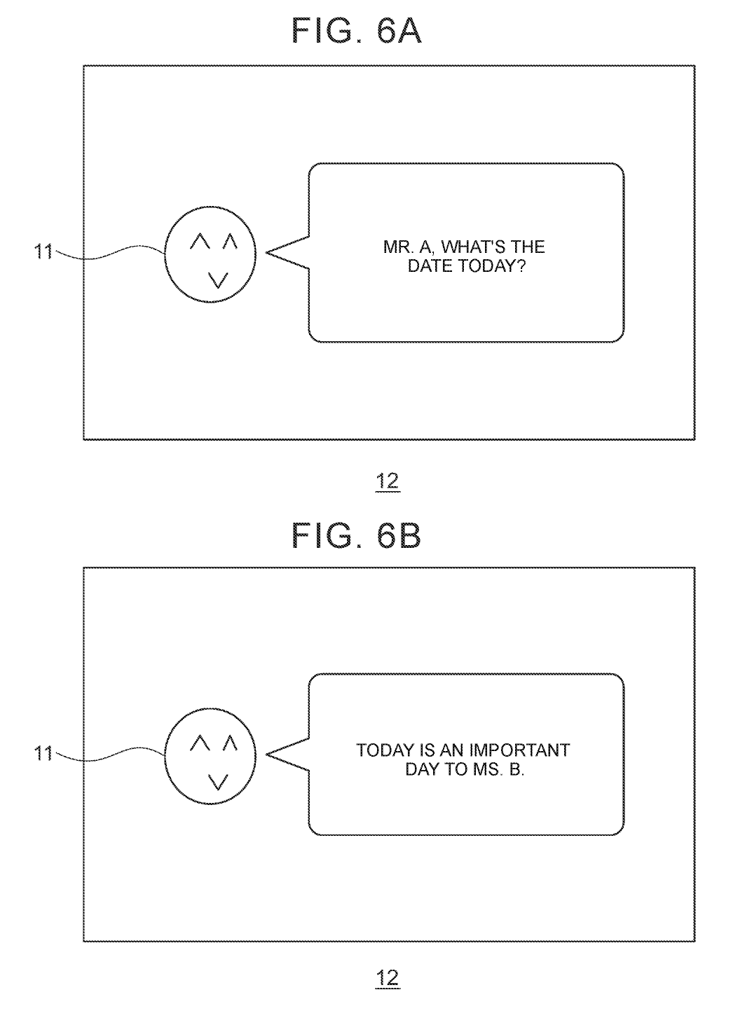

The emotions of the occupants, the situation of a conversation, the situation of an atmosphere, and the speech content of the character 11 in some scenes are exemplified below. FIG. 6A and FIG. 6B illustrate an example of the speech content of the character 11. FIG. 6A and FIG. 6B illustrate a state in which the speech content of the character 11 is displayed on the on-board display device in the form of a speech balloon. In some embodiments, the speech content of the character 11 may be output from the loudspeaker so that the occupant may hear the speech content of the character 11 without viewing the character 11.

This example provides a scene assuming that the occupant B suddenly becomes angry during driving and the occupant A is surprised and confused because the occupant A does not know why the occupant B is angry. Both the situation of the conversation and the atmosphere are very bad. The speech content decision unit 64 finds that the day in the example is the birthday of the occupant B based on the pieces of user attribute information of the occupants A and B. Therefore, the speech content decision unit 64 causes the character 11 to ask, “Mr. A, what's the date today?” Thus, the speech content decision unit 64 prompts the occupant A to notice that the day in the example is the birthday of the occupant B.

If the occupant A does not notice the birthday of the occupant B, however, the speech content decision unit 64 further causes the character 11 to say, “Today is an important day to Ms. B.” Thus, the speech content decision unit 64 gives a hint to the occupant A. Accordingly, the occupant A notices that the day in the example is the birthday of the occupant B. By causing the character 11 to intervene in this manner, the situation of the conversation between the occupants is improved afterwards. Thus, it is expected that the atmosphere may be improved.

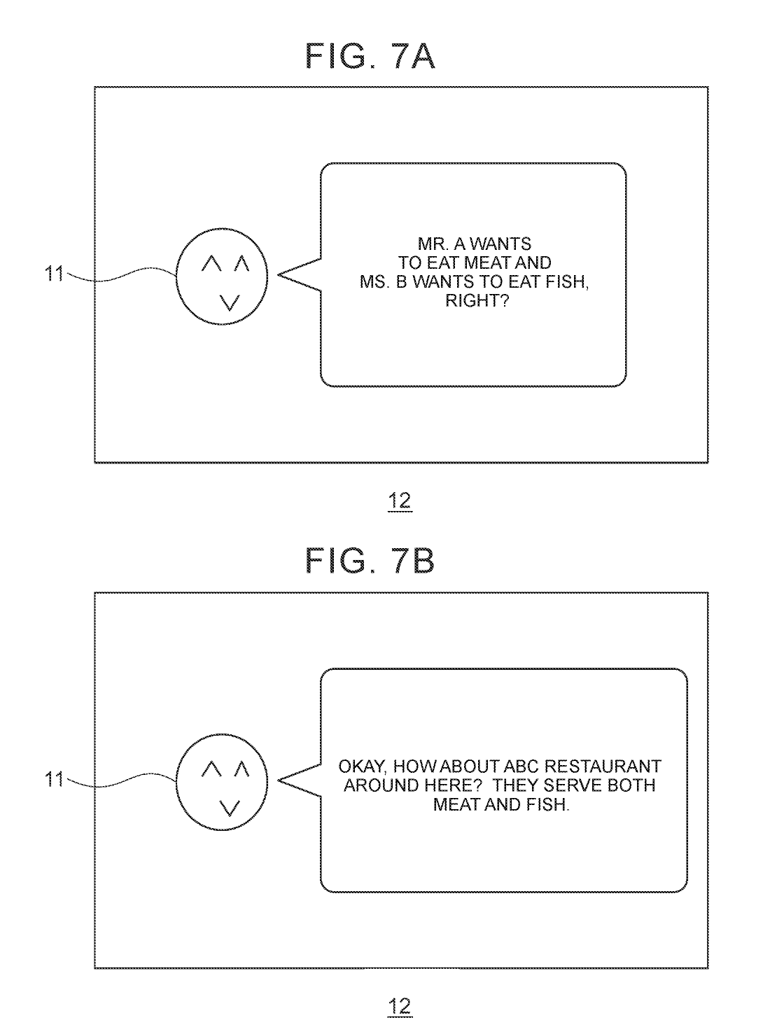

FIG. 7A and FIG. 7B illustrate another example of the speech content of the character 11. In this example as well, the speech content of the character 11 is displayed in the form of a speech balloon, but is output from the loudspeaker.

This example provides a scene assuming that, during driving, the occupants A and B are brought into conflict over what they want to eat and are angry beyond their control. Both the situation of the conversation and the atmosphere are very bad. In order to calm down the two occupants, the speech content decision unit 64 first sums up their opinions, and causes the character 11 to say, “Mr. A wants to eat meat and Ms. B wants to eat fish, right?” If the occupants A and B say or behave in agreement, the speech content decision unit 64 acquires information on a nearby restaurant that serves meat and fish from the navigation application 22, and causes the character 11 to say, “Okay, how about ABC Restaurant around here? They serve both meat and fish.” As described above, when the atmosphere between the two occupants is bad, the speech content decision unit 64 causes the character 11 to intervene in the environment in order to improve the atmosphere.

By referring to a history of previous conversations between the occupants A and B, the speech content decision unit 64 may cause the character 11 to say, “We chose the opinion of Mr. A and went to a steakhouse last time, so how about going to a seafood restaurant to meet the request of Ms. B this time?” By referring to the user attribute information of the occupant A, the speech content decision unit 64 may cause the character 11 to say, “Mr. A has allergy to a certain kind of fish, right?” In this manner, the speech content decision unit 64 may inform the occupant B that the occupant A has allergy. Particularly in a case where the occupants have a superior-subordinate relationship, the subordinate may have hesitation in front of his/her superior. Therefore, the speech content decision unit 64 may cause the character 11 to talk, on behalf of the subordinate, about a subject that he/she hesitates to talk about so as not to spoil the relationship.

The present disclosure has been described above based on the embodiment. The embodiment is illustrative in all respects, and it is apparent to those skilled in the art that various modifications may be made to combinations of constituent elements or processes and the modifications are included in the scope of the present disclosure. In the embodiment, the virtual object having a speech function is described, but the object may be a real object such as a robot.

In the embodiment, it is described that the functions of the occupant condition management unit 30 are provided in the on-board device 10, but the functions may be provided in the server device 3. In this case, the pieces of information acquired in the vehicle 2, that is, the image captured by the camera 13, the voice data from the microphone 14, the detection value from the vehicle sensor 15, and the positional information from the GPS receiver 16 are transmitted from the communication unit 17 to the server device 3. The server device 3 estimates the emotions of the occupants in the vehicle cabin, makes determination on the conversational situation involving the plurality of occupants, and transmits the emotion information and the conversational situation to the vehicle 2.

What is claimed is:

1. A speech system comprising a processor configured to:
acquire a situation value indicating a situation involving a plurality of persons based on pieces of emotion information indicating emotions of the persons; and
control a speech of an object based on the acquired situation value.

2. The speech system according to claim 1, wherein:
the processor is configured to estimate an emotion of each of the persons based on a facial expression of the person and to estimate the emotion of the person based on a voice of a speech of the person; and
the emotion information is emotion information obtained when emotion information estimated based on the facial expression and emotion information estimated based on the voice of the speech agree with each other.

3. The speech system according to claim 1, wherein the object is a virtual object or a real object.

4. The speech system according to claim 1, wherein the processor is configured to acquire the situation value based on a conversational situation involving the persons as well as the emotion information.

5. The speech system according to claim 1, wherein the situation value indicating the situation involving the persons is a value representing a level of a quality of an atmosphere of an environment where the persons are present.

6. The speech system according to claim 5, wherein the situation value is a value indicating one grade out of a plurality of grades into which the quality of the atmosphere is classified.

7. The speech system according to claim 1, wherein the processor is configured to decide whether to cause the object to make the speech based on the situation value.

8. The speech system according to claim 7, wherein the processor is configured such that, when the processor acquires a situation value indicating that an atmosphere of an environment is bad, the processor decides to cause the object to make the speech.

9. The speech system according to claim 7, wherein the processor is configured such that, when the processor acquires a situation value indicating that an atmosphere of an environment is good, the processor decides not to cause the object to make the speech.

10. The speech system according to claim 1, wherein the processor is configured to estimate the emotions of the persons by identifying individual facial expressions in face images of the persons, which are extracted from an image captured by a camera.
